(19) United States
(12) Patent Application Publication
(10) Pub. No.: US 2020/0320652 A1
(43) Pub. Date: Oct. 8, 2020

(54) HETEROGENEOUS REGISTRAR DATA RETRIEVAL FOR MULTI-CAMPUS TUTOR MATCHING

(71) Applicant: THE OTHER RIGHT, LLC, Miami, FL (US)

(72) Inventor: James Nicolo Bates, Miami, FL (US)

(21) Appl. No.: 16/374,716

(22) Filed: Apr. 3, 2019

(51) Int. Cl. G06Q 50/20; G06F 16/9535; H04L 29/06

(52) U.S. Cl. CPC G06Q 50/205; H04L 63/08; G06F 16/9535

(57) ABSTRACT

A method for heterogeneous registrar data retrieval in a tutor matching system includes receiving a request to register an end user of the system, extracting from the request, a specified academic institution, and mapping the institution to a pre-stored profile encapsulating a network address for a registrar data retrieval system of the institution, a first query interface operable to retrieve a contemporaneous course schedule for a student, a second query interface operable to retrieve a transcript for a tutor, and authentication data operable to authenticate access to the registrar data retrieval system. Finally, the method includes submitting authentication data to the retrieval system of the institution according to the pre-stored profile, and upon authentication, querying the mapped first query interface to return a contemporaneous course schedule, the mapped second query interface to return a digital transcript, and storing the schedule and transcript in a record of the end user.

### BACKGROUND OF THE INVENTION

### Field of the Invention

The present invention relates to the field of database integration systems and more particularly to integrating data sourced from a registrar database for an academic institution within a tutor matching system.

### Description of the Related Art

The process of classroom education refers to the attendance by a student in a class instructed by a teacher within a classroom environment at an educational institution. Traditional classroom education involves the delivery of one or more classroom lectures, roundtable discussions or laboratories on a fixed schedule according to a syllabus with one or more graded examinations administered throughout. In so far as the material instructed during a classroom session may be of such density so as to required additional instruction, in many instances, additional private sessions with the instructor may be attended by a student in the form of “office hours”. As well, to the extent that the office hours are not sufficient to service the instructional needs of all students, for many courses, teaching assistants are enlisted to provide additional instruction also in the form of office hours, or alternatively in a group attended additionally scheduled class.

Despite opportunities afforded by classroom instruction and office hours in the academic session, oftentimes, for many students, more personalized attention is required. To that end, in most academic environments, private and small-group tutoring services may be offered, either as an offering of the academic institution, an offering that is separate from but coordinated by the academic institution, or as a third party offering without coordination with the academic institution. In the former instance, the academic institution may allocate space in the physical plant of the campus and hire or contract one or more tutors to be present during certain defined hours within the physical plant. In the latter circumstance, individual, enterprising students may advertise available tutoring services through campus media, printed flyers, online advertising, or by word of mouth. Notwithstanding, the manner in which tutoring services are offered, whether by the academic institution or privately by a third party, is not without its drawbacks.

In this regard, matching a tutor to a prospective student requires that the tutor have some substantial familiarity with the coursework for which the prospective tutor seeks tutoring. Preferably, the prospective tutor has direct familiarity with the course in which the prospective student is registered and in which the coursework has arisen, and ideally, the prospective tutor has direct knowledge if not past experience as a student in that course with the same faculty member conducting the course. Of course, to have an awareness of such knowledge, the system coordinating the matching of tutor to student must access both contemporaneous and historical course registration records at the campus of interest.

Yet, given the strong desire for data privacy and data security, most registrar data retrieval systems are limited in the type of data that can be retrieved and the manner in which the data is retrieved from the registrar data retrieval systems. The problem compounds when the tutor matching system is a system external in all respects from the underlying campus, but seeks to service multiple different campuses, each with its own registrar data retrieval system. The disparity in the ability to access certain types of data and in the format of a request to achieve such access and the format in which data is returned acts as a barrier to success for a third-party tutor matching system seeking to uniformly service all of the campuses.

### BRIEF SUMMARY OF THE INVENTION

Embodiments of the present invention address deficiencies of the art in respect to the retrieval of registrar data from different, heterogeneous registrar data sources and provide a novel and non-obvious method, system and computer program product for heterogeneous registrar data retrieval in a tutor matching system. In an embodiment of the invention, a method for heterogeneous registrar data retrieval in a tutor matching system includes receiving a request to register an end user of the tutor matching system and extracting from the request, a specified academic institution. The method further includes mapping the specified academic institution to a pre-stored profile that encapsulates a network address for a registrar data retrieval system of the specified academic institution, a first query interface operable to retrieve a contemporaneous course schedule for a specified student, a second query interface operable to retrieve a transcript for a specified tutor, and authentication data operable to authenticate access to the registrar data retrieval system so as to enable a response to the first query and a response to the second query. Finally, the method includes submitting authentication data to the registrar data retrieval system mapped to the specified academic institution according to the pre-stored profile, and upon authentication, issuing a first query to the mapped first query interface of the pre-stored profile, the first query returning a contemporaneous course schedule for the end user, issuing a second query to the mapped second query interface of the pre-stored profile, the second query returning a digital transcript for the end user, and storing the contemporaneous course schedule and the digital transcript in a record associated with the end user.

In one aspect of the embodiment, the end user is a registered tutor. As such, the method further includes generating a list of past completed course work from the stored transcript indicative of academic subjects for which the registered tutor may provide tutoring services to registered students, and filtering the list to include only past completed course work in which the registered tutor received a threshold grade or higher as indicated by the stored transcript. In another aspect of the embodiment, the end user is a registered student. Consequently, the method further includes generating a list of subjects from the contemporaneous course schedule for which the registered student is permitted to seek tutoring services.

In yet another aspect of the embodiment, the method includes determining that a pre-stored profile does not exist for the specified academic institution. As a result, in response to the determination, a prompt is displayed to upload a digital scan of a paper transcript of the end user, the paper copy is digitally scanned, a listing of contemporary and past completed courses identified in the digital scan as well as corresponding grades for each of the past completed courses, and the identified listing of contemporary courses is stored as the contemporaneous course schedule of the end user, while the identified listing of past completed courses and corresponding grades are stored as the digital transcript in the record associated with the end user.

Alternatively, in even yet another aspect of the embodiment, it may be determined that a pre-stored profile does not exist for the specified academic institution. In response to the determination, a form is displayed in a user interface to the tutor matching system. The form provides completable fields into which a listing of contemporary and past completed courses are provided along with corresponding grades for each of the past completed courses. Consequently, input is received into the completable fields and the input is stored for the identified listing of contemporary courses as the contemporaneous course schedule of the end user, while the input for the identified listing of past completed courses and corresponding grades may be stored as the digital transcript in the record associated with the end user.

In another embodiment of the invention, a tutor matching data processing system is configured for heterogeneous registrar data retrieval. The system includes a host computing platform that includes a data store and one or more computers, each with memory and at least one processor. The host computing platform has a communicative coupling to different mobile devices of different end users over a computer communications network. A tutor matching engine executes in the host computing platform and matches students requesting tutoring services from respective ones of the mobile devices, with tutors accepting the requested tutoring services from respective ones of the mobile devices. Finally, the system includes a heterogeneous registrar data retrieval module.

The module includes computer program instructions enabled during execution in the memory of the host computing platform to receive a request to register one of the end users and to extract from the request, a specified academic institution. The program instructions further are enabled to map the specified academic institution to a pre-stored profile. The profile encapsulates a network address for a registrar data retrieval system of the specified academic institution, a first query interface operable to retrieve a contemporaneous course schedule for a specified student, a second query interface operable to retrieve a transcript for a specified tutor, and authentication data operable to authenticate access to the registrar data retrieval system so as to enable a response to the first query and a response to the second query.

The program instructions yet further are enabled to submit authentication data to the registrar data retrieval system mapped to the specified academic institution according to the pre-stored profile. Upon authentication, a first query may be issued to the mapped first query interface of the pre-stored profile, the first query returning a contemporaneous course schedule for the end user. As well, a second query may be issued to the mapped second query interface of the pre-stored profile, the second query returning a digital transcript for the end user. Finally, the program instructions are enabled to store in the data store the contemporaneous course schedule and the digital transcript in a record associated with the end user.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is pictorial illustration of a process for heterogeneous registrar data retrieval in a tutor matching system;

FIG. 2 is a schematic illustration of a tutor matching system configured for heterogeneous registrar data retrieval; and,

FIG. 3 is a flow chart illustrating a process for heterogeneous registrar data retrieval in a tutor matching system.

### DETAILED DESCRIPTION OF THE INVENTION

Embodiments of the invention provide for the retrieval of heterogeneous registrar data in a tutor matching system. In accordance with an embodiment of the invention, different students and tutors, collectively, end users, register with the tutor matching system in association with a particular academic institution. Different prospective academic institutions of the end users each may have a differing registrar data retrieval system in which course information and transcript data is stored for students, and therefore, each may provide different mechanisms for authenticating access thereto. As well, each may require a different query interface through which the course information and transcript data may be retrieved therefrom. In this regard, a query interface may include one or more query specific directives of specific format and specific parameterization, transmitted to a particular address and port of a particular server so as to provoke the server to return in reply to the query, the desired information.

So as to accommodate the disparate nature of each of the registrar data retrieval system, a profile may be pre-stored for each one of the academic institutions and respective ones of the heterogeneous registrar data retrieval systems. Each pre-stored profile encapsulates information such as a network address of a corresponding one of the heterogeneous registrar data retrieval systems, a query interface sufficient to retrieve a course listing for a specified student, a query interface sufficient to retrieve a transcript for a specified student, and authentication data sufficient to gain access to the corresponding one of the heterogeneous registrar data retrieval systems. Once the profiles have been pre-stored, the tutor matching system is then able to interoperate with any one of the heterogeneous registrar data retrieval systems as specified by an end user at the time of requesting registration to the tutor matching system.

Specifically, at the time of registration, a specified one of the academic institutions may be determined from a registration request, and a corresponding one of the pre-stored profiles retrieved. The correct one of the heterogeneous registrar data retrieval systems is then identified and the authentication data of the corresponding one of the pre-stored profiles used to authenticate access to the correct one of the heterogeneous registrar data retrieval systems at the encapsulated address. Then, the query interface information of the corresponding one of the pre-stored profiles is used to query the correct one of the heterogeneous registrar data retrieval systems in order to retrieve the course listing and transcript for the end user seeking registration to the tutor matching system. The retrieved information is then stored for subsequent use by the tutor matching system in matching a student seeking tutoring services for a specific subject with a suitable tutor.

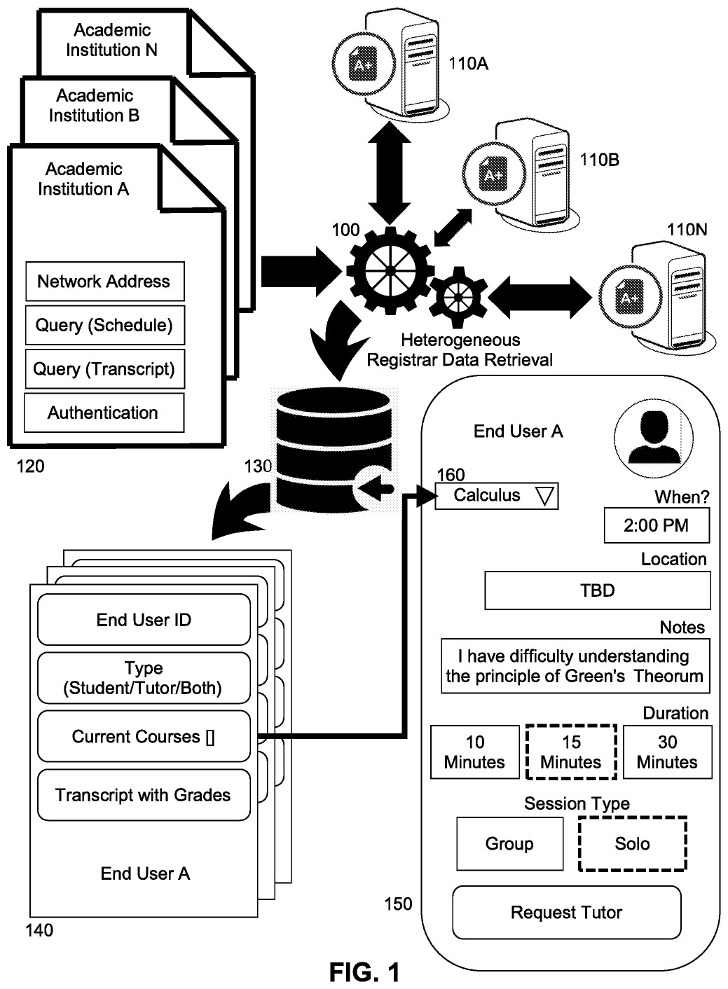

In further illustration, FIG. 1 pictorially shows a process for heterogeneous registrar data retrieval in a tutor matching system. As shown in FIG. 1, different profiles 120 for different academic institutions are pre-stored in connection with heterogeneous registrar data retrieval logic 100 for a tutor matching system. As different end users register with the tutor matching system, a corresponding one of the academic institutions is determined for each end user and a respective one of the pre-stored profiles 120 retrieved. Each one of the pre-stored profiles 120 encapsulates information including a different, correspondent network address of a registrar data retrieval system 110A, 110B, 110N of the corresponding one of the academic institutions, a query interface specific to the registrar data retrieval system 110A, 110B, 110N with which a query may be processed by the registrar data retrieval system 110A, 110B, 110N in order to return a course schedule for a specified registrant (student), a query interface specific to the registrar data retrieval system 110A, 110B, 110N with which a query may be processed by the registrar data retrieval system 110A, 110B, 110N in order to return a transcript for a specified registrant (student or tutor), and authentication data sufficient for an end user to gain access to the registrar data retrieval system 110A, 110B, 110N.

Using the pre-stored profile 120, the heterogeneous registrar data retrieval logic 100 access a correct one of the registrar data retrieval systems 110A, 110B, 110N at the specified network address and in accordance with the authentication data, and issues queries according to the query interfaces of the pre-stored profile 120 in order to retrieve a course listing of a specified end user, and a transcript with grade information for the specified end user. Then, the heterogeneous registrar data retrieval logic 100 populates a data store 130 with different profile records 140 for each registered end user whether the end user is a student or tutor or both. Each of the different profile records 140 includes an identity of the end user, a type of the end user whether student, tutor or both, a listing of contemporaneously registered courses in the event the end user is a student, and a transcript indicating both past and present courses, completed and ongoing, respectively, along with corresponding grades.

As such, utilizing the records 140, as an end user who is a student seeks to request tutoring services through the use of a user interface 150 to the tutor matching system, the tutor matching system populates the user interface field 160 pertaining to a subject for which tutoring may be requested, with the current courses stored in an associated one of the records 140. As well, utilizing the records 140, the tutor matching system may include for consideration as a tutor able to accept the request for tutoring services, only those tutors with transcript information indicating a threshold or higher grade in a selected one of the courses of the request for tutoring services.

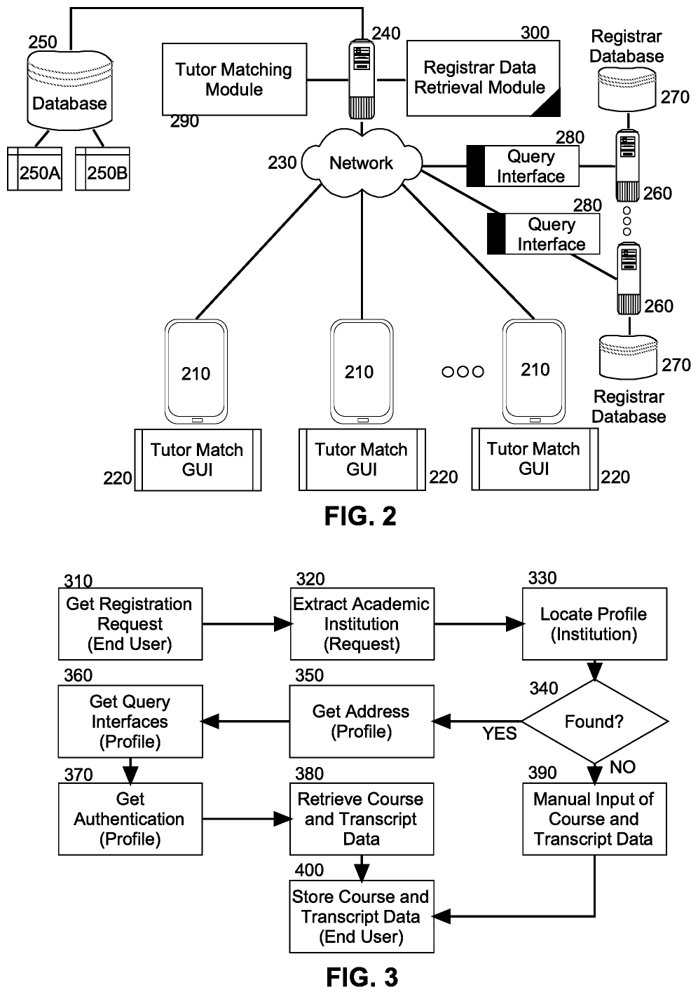

The process described in connection with FIG. 1 may be implemented in a tutor matching data processing system. In yet further illustration, FIG. 2 schematically shows a tutor matching system configured for heterogeneous registrar data retrieval. The system includes a host computing server 240 including one or more computers, each with memory and at least one processor. The host computing server 240 is communicatively linked to different mobile devices 210 over computer communications network 230, each of the mobile devices 210 belonging either to a student in an academic institution, a tutor at the academic institution, or both.

The host computing server 240 includes a database 250 that may include one or more databases either locally present within the host computing server 240, or accessible remotely by the host computing server 240. The database 250 includes a tutor registry 250A and a student table 250B. The tutor registry 250A includes a listing of different tutors registered to perform tutoring services in connection with one or more academic topics, a grade achieved in a class corresponding to each academic topic, and a most recent rating, combination of ratings, or both, as applied to the corresponding tutor. The student table 250B includes a listing of different students registered to receive tutoring services. Of note, the student table 250B includes for each corresponding student, a set of courses for which the corresponding student is contemporaneously registered at the academic institution.

Importantly, a tutor matching module 290 executes in the memory of the host computing server 240. The tutor matching module 290 includes computer program instructions that during execution, receive through a tutor matching user interface 220 in a mobile device 210 of a tutor request for tutoring services in a specified academic topic of interest at a particular time and location for a specified duration of time. The program instructions during execution additionally locate within the tutor registry 250A, a selection of tutors able to perform the requested tutoring services based upon the completion by each of the tutors of a class corresponding to the specified academic topic for which the tutor received from a corresponding academic institution a minimum threshold grade indicated in the tutor registry 250A, such as an “A’.

The program instructions during execution even further broadcast to the selection of tutors, the tutor request for viewing in the user interface 220 of respective ones of the mobile devices 210 of the selection of tutors. The program instructions during execution even yet further receive one or more responses to the broadcast request from ones of the selection of tutors. Finally, the program instructions match a responding one of the tutors to the student issuing the request and upon completion of the tutoring session, transfer credits from the student to the tutor in accordance with a quoted rate for employing the assigned tutor for the tutoring session.

Of note, the system includes a registrar data retrieval module 300. The registrar data retrieval module 300 includes computer program instructions operable for execution in the host computing system so as to populate the tutor registry 250A with transcript data retrieved from a registrar database 270 of a specific academic institution by way of a registrar data retrieval system 260. More particularly, the program instructions are operable to populate the tutor registry 250A through the use of query directives defined by a query interface 280 specific to the registrar data retrieval system 260 and indicated within a pre-stored profile for the specific academic institution. The computer program instructions are further operable during execution in the host computing system 240 to populate the student table 250B with both transcript data and also a contemporaneous listing of courses using the query directives defined by the query interface 280 and indicated within the pre-stored profile for the academic institution.

In even yet further illustration of the operation of the registrar data retrieval module 300, FIG. 3 is a flow chart illustrating a process for heterogeneous registrar data retrieval in a tutor matching system. Beginning in block 310, a registration request is received in a tutor matching system from an end user. In block 320, an academic institution is identified within the request and in block 330, an attempt to locate a pre-stored profile for the the academic institution may be undertaken. In decision block 340, if no pre-stored profile can be located for the academic institution, in block 390, the end user can receive a prompt in a user interface to the tutor matching system to provide input to different input fields of an electronic form indicating a contemporaneous listing of courses and, optionally, transcript data. Alternatively, the end user can be prompted to digitally image and optical character recognize a paper transcript from which the contemporaneous listing of the courses and the transcript data may be determined. But, in decision block 340, if a pre-stored profile can be located for the academic institution, the process may continue through block 350.

In block 350, a network address in the pre-stored profile is extracted along with a query interface in block 360 with which a query may be formulated so as to cause a registrar data retrieval system to return in response to the query, a course listing for a specified end user, a transcript with grades for the specified end user, or both. In block 370, authentication information also may be extracted from the profile. Then, in block 380, the queries are transmitted to the network address and in response, the requested course listing and transcript data are received. Finally, in block 400 the course and transcript data, whether automatically extracted using the pre-stored profile in block 380, or manually determined in block 390, is stored in connection with the specified end user.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network. The computer readable program instructions may execute entirely on the user's computer, partly on the user's computer, as a stand-alone software package, partly on the user's computer and partly on a remote computer or entirely on the remote computer or server. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for heterogeneous registrar data retrieval in a tutor matching system comprising:
receiving a request to register an end user of the tutor matching system;
extracting from the request, a specified academic institution;
mapping the specified academic institution to a pre-stored profile, the profile encapsulating a network address for a registrar data retrieval system of the specified academic institution, a first query interface operable to retrieve a contemporaneous course schedule for a specified student, a second query interface operable to retrieve a transcript for a specified tutor, and authentication data operable to authenticate access to the registrar data retrieval system so as to enable a response to the first query and a response to the second query;
submitting authentication data to the registrar data retrieval system mapped to the specified academic institution according to the pre-stored profile, and upon authentication, issuing a first query to the mapped first query interface of the pre-stored profile, the first query returning a contemporaneous course schedule for the end user, and issuing a second query to the mapped second query interface of the pre-stored profile, the second query returning a digital transcript for the end user; and,
storing the contemporaneous course schedule and the digital transcript in a record associated with the end user.

2. The method of claim 1, wherein the end user is a registered tutor, the method further comprising generating a list of past completed course work from the stored transcript indicative of academic subjects for which the registered tutor may provide tutoring services to registered students, and filtering the list to include only past completed course work in which the registered tutor received a threshold grade or higher as indicated by the stored transcript.

3. The method of claim 1, wherein the end user is a registered student, the method further comprising generating a list of subjects from the contemporaneous course schedule for which the registered student is permitted to seek tutoring services.

4. The method of claim 1, further comprising:
determining that a pre-stored profile does not exist for the specified academic institution; and,
in response to the determination, displaying a prompt to upload a digital scan of a paper transcript of the end user, digitally scanning the paper copy, identifying a listing of contemporary and past completed courses in the digital scan and corresponding grades for each of the past completed courses and storing identified listing of contemporary courses as the contemporaneous course schedule of the end user, and the identified listing of past completed courses and corresponding grades as the digital transcript in the record associated with the end user.

5. The method of claim 1, further comprising:
determining that a pre-stored profile does not exist for the specified academic institution; and,
in response to the determination, displaying a form in a user interface to the tutor matching system, the form providing completable fields into which a listing of contemporary and past completed courses are provided along with corresponding grades for each of the past completed courses, receiving input into the completable fields and storing the input for the identified listing of contemporary courses as the contemporaneous course schedule of the end user, and the input for the identified listing of past completed courses and corresponding grades as the digital transcript in the record associated with the end user.

6. A tutor matching data processing system configured for heterogeneous registrar data retrieval, the system comprising:
a host computing platform comprising a data store and one or more computers, each with memory and at least one processor, the host computing platform having a communicative coupling to different mobile devices of different end users over a computer communications network;
a tutor matching engine executing in the host computing platform and matching students requesting tutoring services from respective ones of the mobile devices, with tutors accepting the requested tutoring services from respective ones of the mobile devices; and,
a heterogeneous registrar data retrieval module comprising computer program instructions enabled during execution in the memory of the host computing platform to perform:
receiving a request to register one of the end users;
extracting from the request, a specified academic institution;
mapping the specified academic institution to a pre-stored profile, the profile encapsulating a network address for a registrar data retrieval system of the specified academic institution, a first query interface operable to retrieve a contemporaneous course schedule for a specified student, a second query interface operable to retrieve a transcript for a specified tutor, and authentication data operable to authenticate access to the registrar data retrieval system so as to enable a response to the first query and a response to the second query;
submitting authentication data to the registrar data retrieval system mapped to the specified academic institution according to the pre-stored profile, and upon authentication, issuing a first query to the mapped first query interface of the pre-stored profile, the first query returning a contemporaneous course schedule for the end user, and issuing a second query to the mapped second query interface of the pre-stored profile, the second query returning a digital transcript for the end user; and,
storing in the data store the contemporaneous course schedule and the digital transcript in a record associated with the end user.

7. The system of claim 6, wherein the end user is a registered tutor, and wherein the program instructions further perform generating a list of past completed course work from the stored transcript indicative of academic subjects for which the registered tutor may provide tutoring services to registered students, and filtering the list to include only past completed course work in which the registered tutor received a threshold grade or higher as indicated by the stored transcript.

8. The system of claim 6, wherein the end user is a registered student, and wherein the program instructions further perform generating a list of subjects from the contemporaneous course schedule for which the registered student is permitted to seek tutoring services.

9. The system of claim 6, wherein the program instructions further perform:
determining that a pre-stored profile does not exist for the specified academic institution; and,
in response to the determination, displaying a prompt to upload a digital scan of a paper transcript of the end user, digitally scanning the paper copy, identifying a listing of contemporary and past completed courses in the digital scan and corresponding grades for each of the past completed courses and storing identified listing of contemporary courses as the contemporaneous course schedule of the end user, and the identified listing of past completed courses and corresponding grades as the digital transcript in the record associated with the end user.

10. The system of claim 6, wherein the program instructions further perform:
determining that a pre-stored profile does not exist for the specified academic institution; and,
in response to the determination, displaying a form in a user interface to the tutor matching system, the form providing completable fields into which a listing of contemporary and past completed courses are provided along with corresponding grades for each of the past completed courses, receiving input into the completable fields and storing the input for the identified listing of contemporary courses as the contemporaneous course schedule of the end user, and the input for the identified listing of past completed courses and corresponding grades as the digital transcript in the record associated with the end user.

11. A computer program product for heterogeneous registrar data retrieval in a tutor matching system, the computer program product including a computer readable storage medium having program instructions embodied therewith, the program instructions executable by a device to cause the device to perform a method including:
receiving a request to register an end user of the tutor matching system;
extracting from the request, a specified academic institution;
mapping the specified academic institution to a pre-stored profile, the profile encapsulating a network address for a registrar data retrieval system of the specified academic institution, a first query interface operable to retrieve a contemporaneous course schedule for a specified student, a second query interface operable to retrieve a transcript for a specified tutor, and authentication data operable to authenticate access to the registrar data retrieval system so as to enable a response to the first query and a response to the second query;
submitting authentication data to the registrar data retrieval system mapped to the specified academic institution according to the pre-stored profile, and upon authentication, issuing a first query to the mapped first query interface of the pre-stored profile, the first query returning a contemporaneous course schedule for the end user, and issuing a second query to the mapped second query interface of the pre-stored profile, the second query returning a digital transcript for the end user; and,
storing the contemporaneous course schedule and the digital transcript in a record associated with the end user.

12. The computer program product of claim 11, wherein the end user is a registered tutor, the method further comprising generating a list of past completed course work from the stored transcript indicative of academic subjects for which the registered tutor may provide tutoring services to registered students, and filtering the list to include only past completed course work in which the registered tutor received a threshold grade or higher as indicated by the stored transcript.

13. The computer program product of claim 11, wherein the end user is a registered student, the method further comprising generating a list of subjects from the contemporaneous course schedule for which the registered student is permitted to seek tutoring services.

14. The computer program product of claim 11, wherein the method further comprises:
determining that a pre-stored profile does not exist for the specified academic institution; and,
in response to the determination, displaying a prompt to upload a digital scan of a paper transcript of the end user, digitally scanning the paper copy, identifying a listing of contemporary and past completed courses in the digital scan and corresponding grades for each of the past completed courses and storing identified listing of contemporary courses as the contemporaneous course schedule of the end user, and the identified listing of past completed courses and corresponding grades as the digital transcript in the record associated with the end user.

15. The computer program product of claim 11, wherein the method further comprises:
determining that a pre-stored profile does not exist for the specified academic institution; and,
in response to the determination, displaying a form in a user interface to the tutor matching system, the form providing completable fields into which a listing of contemporary and past completed courses are provided along with corresponding grades for each of the past completed courses, receiving input into the completable fields and storing the input for the identified listing of contemporary courses as the contemporaneous course schedule of the end user, and the input for the identified listing of past completed courses and corresponding grades as the digital transcript in the record associated with the end user.
